(19) United States
(12) Patent Application Publication
(10) Pub. No.: US 2020/0047490 A1
(43) Pub. Date: Feb. 13, 2020

(54) INKJET RECORDING APPARATUS AND IMAGE FORMING METHOD

(71) Applicant: KYOCERA Document Solutions Inc., Osaka (JP)

(72) Inventor: Takuya FUKATA, Osaka-shi (JP)

(73) Assignee: KYOCERA Document Solutions Inc., Osaka (JP)

(21) Appl. No.: 16/533,846

(22) Filed: Aug. 7, 2019

(30) Foreign Application Priority Data
Aug. 9, 2018 (JP) 2018-150181

(51) Int. Cl. B41J 2/045

(52) U.S. Cl. CPC B41J 2/0451

(57) ABSTRACT

An inkjet recording apparatus includes an image forming section and a controller. The image forming section includes a plurality of nozzles, and injects ink from the plurality of nozzles to form an image on a recording medium. The controller controls the image forming section. The controller includes a determining section, a changing section, and a generating section. The determining section determines whether or not each of the plurality of nozzles is clogged with the ink in a thickened state. The changing section changes the nozzle to inject the ink, from a first nozzle to a second nozzle, based on a determination result of the determining section. The generating section generates image data based on the determination result of the determining section. The controller controls the image forming section to inject the ink from the second nozzle to form an image on the recording medium based on the image data.

### INCORPORATION BY REFERENCE

The present application claims priority under 35 U.S.C. § 119 to Japanese Patent Application No. 2018-150181, filed on Aug. 9, 2018. The contents of this application are incorporated herein by reference in their entirety.

### BACKGROUND

The present disclosure relates to an inkjet recording apparatus and an image forming method.

In general, an inkjet recording apparatus capable of correcting nonuniformity in an image caused by a nozzle that injects ink in an abnormal state (hereinafter, referred to as an “abnormally injecting nozzle”) is known. One such inkjet recording apparatus includes a recording head, a detecting section, and a correcting section. The recording head includes a plurality of nozzles. The plurality of nozzles include an abnormally injecting nozzle and a normal nozzle. The detecting section detects the abnormally injecting nozzle among the plurality of nozzles. The correcting section increases the amount of liquid drops injected from the normal nozzle. The normal nozzle injects the liquid drops to form a dot adjacent to a dot corresponding to the abnormally injecting nozzle. According to one such inkjet recording apparatus, the amount of the liquid drops injected from the normal nozzle is increased, and therefore, the dot corresponding to the abnormally injecting nozzle may be formed with such an increased amount of the liquid drops.

### SUMMARY

An inkjet recording apparatus according to one aspect of the present disclosure includes an image forming section and a controller. The image forming section includes a plurality of nozzles, and injects ink from the plurality of nozzles to form an image on a recording medium. The controller controls the image forming section. The controller includes a determining section, a changing section, and a generating section. The determining section determines whether or not each of the plurality of nozzles is clogged with the ink in a thickened state. The changing section changes the nozzle to inject the ink, from a first nozzle to a second nozzle, based on a determination result of the determining section. The generating section generates image data based on the determination result of the determining section. The controller controls the image forming section to inject the ink from the second nozzle to form an image on the recording medium based on the image data. The first nozzle is clogged with the ink in the thickened state. The second nozzle is different from the first nozzle.

An image forming method according to one aspect of the present disclosure is an image forming method performed by an inkjet recording apparatus including an image forming section injecting ink from a plurality of nozzles to form an image on a recording medium. The method includes controlling, determining, changing, generating, and forming. In the controlling, the image forming section is controlled. In the determining, it is determined whether or not each of the plurality of nozzles is clogged with the ink in a thickened state. In the changing, the nozzle to inject the ink is changed from a first nozzle to a second nozzle, based on a determination result on whether or not each of the plurality of nozzles is clogged with the ink. In the generating, image data is generated based on the determination result on whether or not each of the plurality of nozzles is clogged with the ink. In the forming, the image forming section injects the ink from the second nozzle to form an image on the recording medium based on the image data. The first nozzle is clogged with the ink. The second nozzle is different from the first nozzle.

### BRIEF DESCRIPTION OF THE DRAWINGS

FIG. 1 illustrates a structure of an inkjet recording apparatus according to an embodiment of the present disclosure.

FIG. 2 illustrates a bottom surface of four line heads.

FIG. 3 is a block diagram illustrating a controller of the inkjet recording apparatus.

FIG. 4A illustrates a test pattern.

FIG. 4B illustrates a check pattern.

FIG. 5 illustrates an injecting section.

FIG. 6A illustrates a first pattern.

FIG. 6B illustrates a second pattern.

FIG. 6C illustrates a third pattern.

FIG. 6D illustrates a fourth pattern.

FIG. 7A illustrates a state before a timing at which an image representing the first pattern is formed on a recording medium is adjusted.

FIG. 7B illustrates a state after the timing at which the image representing the first pattern is formed on the recording medium is adjusted.

FIG. 8A illustrates a position at which the image representing the first pattern is formed.

FIG. 8B illustrates a position at which an image representing a second pattern is formed.

FIG. 8C illustrates a position at which an image representing a third pattern is formed.

FIG. 8D illustrates a position at which an image representing a fourth pattern is formed.

FIG. 9 illustrates an image formed in an image formation region.

FIG. 10 is a flowchart illustrating a process executed by the controller.

### DETAILED DESCRIPTION

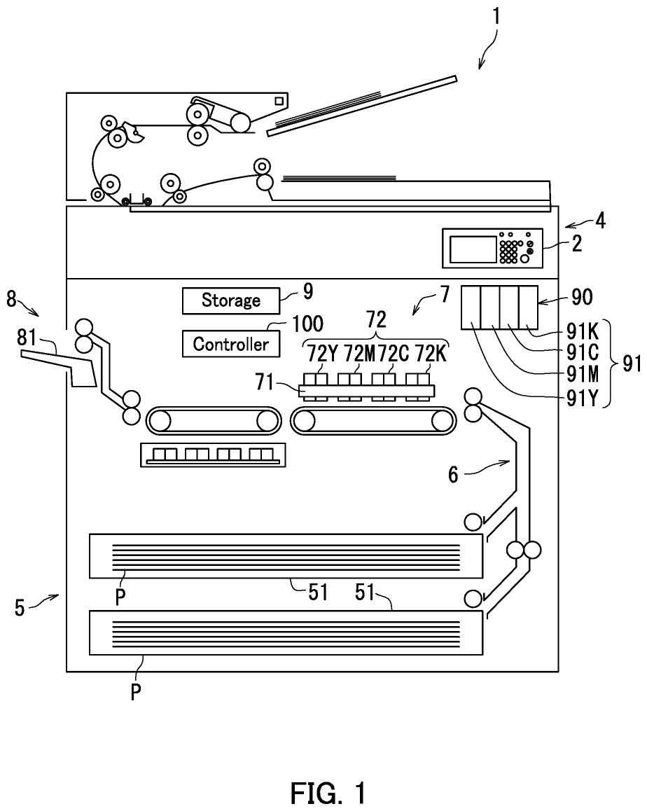

First, with reference to FIG. 1, a structure of an inkjet recording apparatus 1 will be described. FIG. 1 illustrates a structure of the inkjet recording apparatus 1 according to an embodiment of the present disclosure.

As illustrated in FIG. 1, the inkjet recording apparatus 1 includes an operation panel 2, a reading section 4, a sheet accommodating section 5, a conveyance mechanism 6, an image forming section 7, an ink supply device 90, an ejection device 8, storage 9, and a controller 100.

The operation panel 2 receives an instruction from a user to the inkjet recording apparatus 1. The operation panel 2 includes a notifying section and a plurality of keys. Upon receipt of an instruction from the user, the operation panel 2 transmits a signal representing the instruction from the user to the controller 100. The notifying section includes, for example, a liquid crystal display or an organic electro-luminescence (EL) display.

The reading section 4 reads an image formed on a recording medium S. Specifically, the reading section 4 reads an image formed on the recording medium S based on image data. The reading section 4 is a scanner that acquires the image data from the recording medium S. The image data acquired by the reading section 4 corresponds to “read data RD”.

The sheet accommodating section 5 includes a cassette 51. Specifically, the sheet accommodating section 5 includes a plurality of cassettes 51 accommodating recording mediums S. The recording mediums S fed from each of the cassette 51 are each conveyed to the conveyance mechanism 6.

The conveyance mechanism 6 conveys the recording medium S. Specifically, the conveyance mechanism 6 conveys the recording medium S such that the recording medium S passes below the image forming section 7. After the recording medium S passes below the image forming section 7, the conveyance mechanism 6 conveys the recording medium S to the ejection device 8.

The image forming section 7 injects ink to form an image on the recording medium S. The image forming section 7 includes a head housing 71 and four line heads 72. The head housing 71 supports the four line heads 72.

The ink supply device 90 supplies the ink to the image forming section 7. The ink supply device 90 includes ink tanks 91. The ink tanks 91 accommodate the ink. The ink tanks 91 are provided in correspondence with colors of the ink. Specifically, the ink tanks 91 include an ink tank 91Y storing yellow ink, an ink tank 91M storing magenta ink, an ink tank 91C storing cyan ink, and an ink tank 91K storing black ink.

The ejection device 8 includes an exit tray 81. The ejection device 8 ejects the recording medium S to the outside of a housing of the inkjet recording apparatus 1. The recording medium S ejected to the outside of the housing is loaded on the exit tray 81.

The storage 9 stores data. The storage 9 includes a storage device and semiconductor memories. The storage device includes, for example, a hard disk drive (HDD) and/or a solid state drive (SSD). The semiconductor memories act as, for example, a random access memory (RAM) and a read only memory (ROM). The storage 9 stores a control program.

The storage 9 stores image data. The image data includes a test pattern TP. The test pattern TP is image data that represents an image formed when the ink is injected from each of a plurality of nozzles.

The controller 100 includes a processor such as a central processing unit (CPU) or the like. The controller 100 executes a control program to control an operation of various components of the inkjet recording apparatus 1. The controller 100 controls, for example, the image forming section 7. The controller 100 includes an integrated circuit for image forming processing. The integrated circuit for image forming processing includes, for example, an application specific integrated circuit (ASIC).

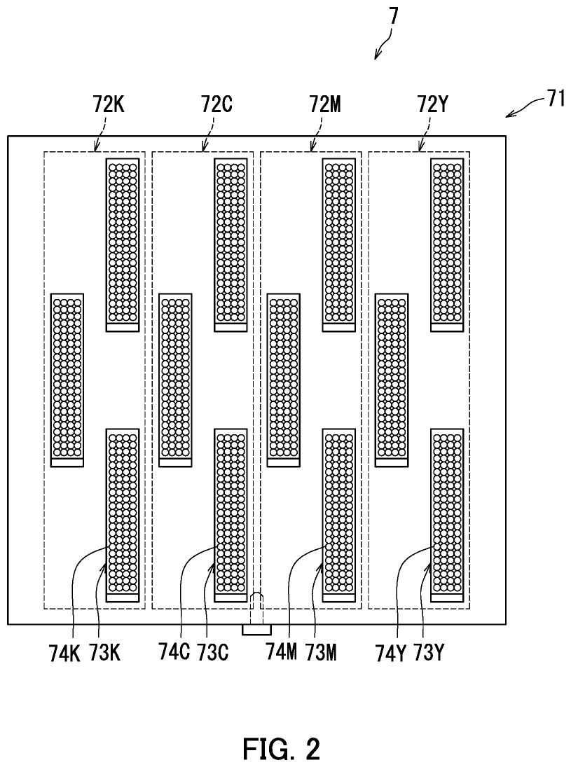

Now, with reference to FIGS. 1 and 2, a structure of the image forming section 7 will be described. FIG. 2 illustrates a bottom surface of the four line heads 72. As illustrated in FIG. 2, the four lines heads 72 each include a plurality of injecting sections 73. The plurality of injecting sections 73 each include a plurality of nozzles 74. In other words, the image forming section 7 includes the four line heads 72. The image forming section 7 includes a plurality of injecting sections 73. The image forming section 7 includes a plurality of nozzles 74, and injects the ink from the plurality of nozzles 74 to form an image on the recording medium S.

As illustrated in FIGS. 1 and 2, the line head 72 injecting the yellow ink is represented as a “line head 72Y”. The line head 72 injecting the magenta ink is represented as a “line head 72M”. The line head 72 injecting the cyan ink is represented as a “line head 72C”. The line head 72 injecting the black ink is represented as “line head 72K”.

In each of the plurality of line heads 72, the plurality of injecting sections 73 are located. The plurality of injecting sections 73 are located in a zigzag manner. The plurality of injecting sections 73 included in the image forming section 7 injecting sections 73Y corresponding to the yellow ink, injecting sections 73M corresponding to the magenta ink, injecting sections 73C corresponding to the cyan ink, and injecting sections 73K corresponding to the black ink.

In each of the plurality of injecting sections 73, the plurality of nozzles 74 are located. The plurality of nozzles 74 are located in an array. Specifically, 23 nozzles 74 are arrayed in a longitudinal direction of each injecting section 73. Four nozzles 74 are arrayed in a shorter direction of each injecting section 73. The direction in which the four nozzles 74 are arrayed matches the direction in which the recording medium S is conveyed.

The plurality of nozzles 74 each inject the ink toward the recording medium S. Specifically, the plurality of nozzles 74 each inject the ink toward a drop landing position that is set on the recording medium S by the controller 100. The “drop landing position” is a position at which the ink injected from the nozzle 74 lands.

The plurality of nozzles 74 included in the image forming section 7 include nozzles 74Y corresponding to the yellow ink, nozzles 74M corresponding to the magenta ink, nozzles 74C corresponding to the cyan ink, and nozzles 74K corresponding to the black ink. The nozzles 74Y are located in the injecting sections 73Y of the line head 72Y. The nozzles 74M are located in the injecting sections 73M of the line head 72M. The nozzles 74C are located in the injecting sections 73C of the line head 72C. The nozzles 74K are located in the injecting sections 73K of the line head 72K.

The line head 72Y is connected with the ink tank 91Y for the yellow ink. The nozzles 74Y inject the yellow ink. The line head 72M is connected with the ink tank 91M for the magenta ink. The nozzles 74M inject the magenta ink. The line head 72C is connected with the ink tank 91C for the cyan ink. The nozzles 74C inject the cyan ink. The line head 72K is connected with the ink tank 91K for the black ink. The nozzles 74K inject the black ink.

The nozzles 74 may each adopt an ink injecting system such as a piezo system or the like. According to the piezo system, ink is injected by use of a piezo element. In more detail, according to the piezo system, a pulse having a predetermined waveform is input to a piezo element, so that the piezo element is deformed so as to correspond to the pulse. As a result, a pressure provided by the deformation of the piezo element is transmitted to the ink in the nozzle 74, and thus the ink is vibrated. As a result, the ink is injected from the nozzle 74.

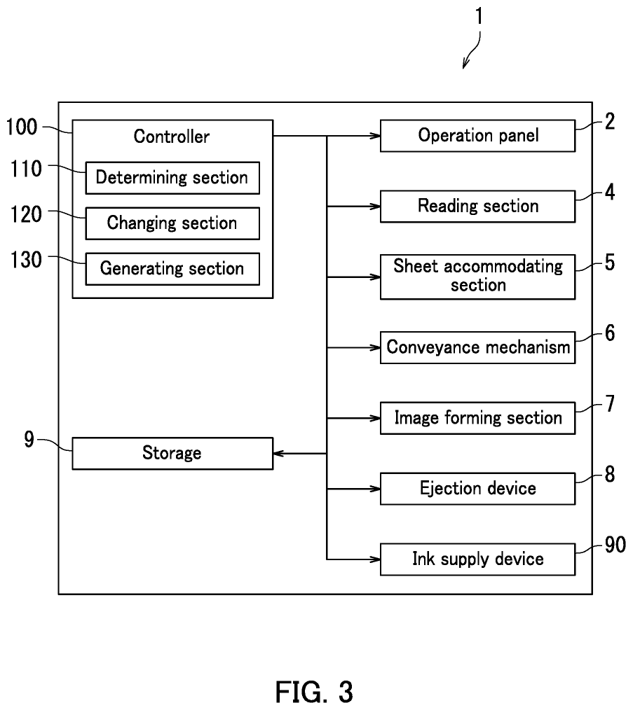

Now, with reference to FIGS. 1 through 3, the controller 100 will be described. FIG. 3 is a block diagram illustrating the controller 100 of the inkjet recording apparatus 1. The controller 100 includes a determining section 110, a changing section 120, and a generating section 130. As illustrated in FIG. 3, the controller 100 executes a control program to act as the determining section 110, the changing section 120, and the generating section 130.

The controller 100 controls the image forming section 7. Specifically, the controller 100 controls the image forming section 7 to inject ink from each of the nozzles 74 to form an image on the recording medium S, based on image data.

In order to control the image forming section 7 to inject ink from each of the nozzles 74, the controller 100 controls the piezo element corresponding to the nozzle 74. The controller 100 controls the piezo element corresponding to the nozzle 74, and thus determines the nozzle 74 from which the ink is to be injected.

The determining section 110 determines whether each of the nozzles 74 is clogged with ink in a thickened state (hereinafter, referred to as the “thickened ink”). When the nozzle 74 is clogged with the thickened ink, the amount of the ink injected from the nozzle 74 is decreased. Alternatively, when the nozzle 74 is clogged with the thickened ink, no ink is injected from the nozzle 74.

The changing section 120 changes the nozzle 74 from which the ink is to be injected. Specifically, the changing section 120 changes the nozzle 74 from which the ink is to be injected, based on the determination result of the determining section 110. More specifically, the changing section 120 changes the nozzle 74 from which the ink is to be injected, from a first nozzle to a second nozzle, based on the determination result of the determining section 110. The first nozzle is the nozzle 74 clogged with the thickened ink. The nozzle 74 clogged with the thickened ink may be in a state where no ink is injected at all or in a state where the ink is injected merely in an insufficient amount. The second nozzle is different from the first nozzle. The second nozzle is the nozzle 74 not clogged with the thickened ink.

The generating section 130 generates image data. Specifically, the generating section 130 generates image data based on the determination result of the determining section 110. The image data generated by the generating section 130 causes the ink to be injected from the second nozzle. The image data includes first image data and second image data. The first image data shows that the ink is injected toward a position excluding a predetermined position. The predetermined position is a drop landing position corresponding to the nozzle 74 clogged with the thickened ink. The second image data shows that the ink is injected from the second nozzle only toward the predetermined position.

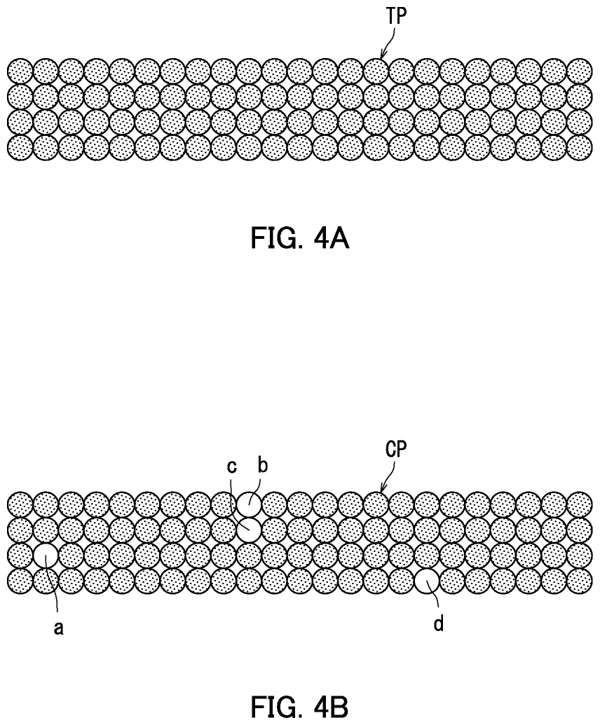

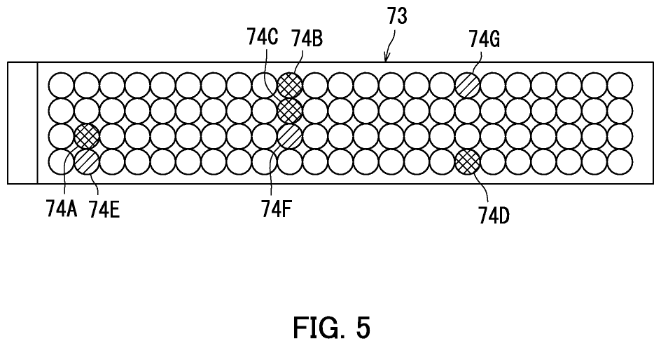

Now, with reference to FIGS. 4A, 4B and 5, a process for determining whether or not the nozzle 74 is clogged with thickened ink will be described.

FIG. 4A illustrates the test pattern TP. The test pattern TP is image data of an image that is formed when the ink is injected from each of the plurality of nozzles 74 in the state where the nozzles 74 are not clogged with the thickened ink. The test pattern TP is stored on the storage 9.

FIG. 4B illustrates a check pattern CP. The check pattern CP is image data of an image that is formed when the image forming section 7 is controlled to inject the ink from each of the plurality of nozzles 74. As illustrated in FIG. 4B, the check pattern CP includes a drop landing position a, a drop landing position b, a drop landing position c, and a drop landing position d. The drop landing position a, the drop landing position b, the drop landing position c, and the drop landing position d are drop landing positions to which no ink was injected.

FIG. 5 illustrates the injecting section 73. The plurality of nozzles 74 in the injecting section 73 include a nozzle 74A, a nozzle 74B, a nozzle 74C, and a nozzle 74D. The drop landing position a illustrated in FIG. 4B corresponds to the nozzle 74A. The drop landing position b illustrated in FIG. 4B corresponds to the nozzle 74B. The drop landing position c illustrated in FIG. 4B corresponds to the nozzle 74C. The drop landing position d illustrated in FIG. 4B corresponds to the nozzle 74D.

In order to determine whether or not each nozzle 74 is clogged with thickened ink, the determining section 110 uses data representing the test pattern TP and data representing the check pattern CP. Specifically, the determining section 110 determines whether or not the data representing the test pattern TP and the data representing the check pattern CP match each other for each nozzle 74. In the case where the data representing the test pattern TP and the data representing the check pattern CP match each other, the determining section 110 determines that the nozzle 74 is not clogged with the thickened ink. In the case where the data representing the test pattern TP and the data representing the check pattern CP do not match each other, the determining section 110 determines that the nozzle 74 is clogged with the thickened ink.

In order to, for example, determine whether or not the nozzle 74A illustrated in FIG. 5 is clogged with thickened ink, the determining section 110 determines whether or not data representing the drop landing position a of the test pattern TP and data representing the drop landing position a of the check pattern CP match each other. As illustrated in FIG. 4B, no ink was injected to the drop landing position a. Therefore, the determining section 110 determines that the data representing the drop landing position a of the test pattern TP and the data representing the drop landing position a of the check pattern CP do not match each other. As a result, the determining section 110 determines that the nozzle 74A corresponding to the drop landing position a is clogged with the thickened ink.

In order to, for example, determine whether or not the nozzle 74B illustrated in FIG. 5 is clogged with thickened ink, the determining section 110 determines whether or not data representing the drop landing position b of the test pattern TP and data representing the drop landing position b of the check pattern CP match each other. As illustrated in FIG. 4B, no ink was injected to the drop landing position b. Therefore, the determining section 110 determines that the data representing the drop landing position b of the test pattern TP and the data representing the drop landing position b of the check pattern CP do not match each other. As a result, the determining section 110 determines that the nozzle 74B corresponding to the drop landing position b is clogged with the thickened ink.

In order to, for example, determine whether or not the nozzle 74C illustrated in FIG. 5 is clogged with thickened ink, the determining section 110 determines whether or not data representing the drop landing position c of the test pattern TP and data representing the drop landing position c of the check pattern CP match each other. As illustrated in FIG. 4B, no ink was injected to the drop landing position c. Therefore, the determining section 110 determines that the data representing the drop landing position c of the test pattern TP and the data representing the drop landing position c of the check pattern CP do not match each other. As a result, the determining section 110 determines that the nozzle 74C corresponding to the drop landing position c is clogged with the thickened ink.

In order to, for example, determine whether or not the nozzle 74D illustrated in FIG. 5 is clogged with thickened ink, the determining section 110 determines whether or not data representing the drop landing position d of the test pattern TP and data representing the drop landing position d of the check pattern CP match each other. As illustrated in FIG. 4B, no ink was injected to the drop landing position d. Therefore, the determining section 110 determines that the data representing the drop landing position d of the test pattern TP and the data representing the drop landing position d of the check pattern CP do not match each other. As a result, the determining section 110 determines that the nozzle 74D corresponding to the drop landing position d is clogged with the thickened ink.

In this manner, the determining section 110 determines which nozzles 74 are clogged with the thickened ink.

Now, with reference to FIGS. 4A, 4B and 5, a process performed by the changing section 120 will be described. As illustrated in FIG. 5, the injecting section 73 further includes a nozzle 74E, a nozzle 74F, and a nozzle 74G. The nozzle 74E is located so as to be on the same line as the nozzle 74A. The nozzle 74F is located so as to be on the same line as the nozzle 74B and the nozzle 74C. The nozzle 74G is located so as to be on the same line as the nozzle 74D.

In the case where the nozzle 74 to inject the ink is to be changed from the first nozzle to the second nozzle, the generating section 130 generates image data showing that the nozzle 74 located in the vicinity of the first nozzle injects ink. For example, the generating section 130 generates image data showing that the nozzle 74 located on a first direction side with respect to the first nozzle injects ink. The “first direction” is, for example, a direction from the nozzle 74C to the nozzle 74B. The nozzle 74 located on the first direction side with respect to the first nozzle is located in the same column as the first nozzle. For example, the generating section 130 generates image data. The image data generated by the generating section 130 shows that the nozzle 74 located on a second direction side with respect to the first nozzle injects the ink. The “second direction” is, for example, a direction from the nozzle 74C to the nozzle 74F. The nozzle 74 located on the second direction side with respect to the first nozzle is located in the same column as the first nozzle.

The determining section 110 determines whether or not the image data generated by the generating section 130 and the data representing the test pattern TP match each other. In the case where the image data generated by the generating section 130 and the data representing the test pattern TP match each other, the changing section 120 changes the nozzle 74 to inject the ink, from the first nozzle to the second nozzle, based on such a determination result of the determining section 110.

In the case where, for example, the nozzle 74A is clogged with the thickened ink, the generating section 130 generates image data showing that the nozzle 74E injects the ink. The nozzle 74E is not clogged with the thickened ink. Specifically, the determining section 110 determines whether or not the image data generated by the generating section 130 and the data representing the test pattern TP match each other, and based on the determination result of the determining section 110, the changing section 120 changes the nozzle 74 to inject the ink, from the nozzle 74A to the nozzle 74E. As a result, the nozzle 74 to inject the ink toward the drop landing position a is changed to the nozzle 74E.

In the case where, for example, the nozzle 74B is clogged with the thickened ink, the generating section 130 generates image data showing that the nozzle 74F injects the ink. The nozzle 74F is not clogged with the thickened ink. The determining section 110 determines whether or not the image data generated by the generating section 130 and the data representing the test pattern TP match each other. Based on the determination result of the determining section 110, the changing section 120 changes the nozzle 74 to inject the ink, from the nozzle 74B to the nozzle 74F. As a result, the nozzle 74 to inject the ink toward the drop landing position b is changed to the nozzle 74F.

In the case where, for example, the nozzle 74C is clogged with the thickened ink, the generating section 130 generates image data showing that the nozzle 74F injects the ink. The nozzle 74F is not clogged with the thickened ink. The determining section 110 determines whether or not the image data generated by the generating section 130 and the data representing the test pattern TP match each other. Based on the determination result of the determining section 110, the changing section 120 changes the nozzle 74 to inject the ink, from the nozzle 74C to the nozzle 74F. As a result, the nozzle 74 to inject the ink toward the drop landing position c is changed to the nozzle 74F.

In the case where, for example, the nozzle 74D is clogged with the thickened ink, the generating section 130 generates image data showing that the nozzle 74G injects the ink. The nozzle 74G is not clogged with the thickened ink. The determining section 110 determines whether or not the image data generated by the generating section 130 and the data representing the test pattern TP match each other. Based on the determination result of the determining section 110, the changing section 120 changes the nozzle 74 to inject the ink, from the nozzle 74D to the nozzle 74G. As a result, the nozzle 74 to inject the ink toward the drop landing position d is changed to the nozzle 74G.

Now, with reference to FIGS. 4A through 6D, a process by which the generating section 130 generates image data will be described. The image data includes a first pattern P1, a second pattern P2, a third pattern P3, and a fourth pattern P4. Based on the determination result of the determining section 110, the generating section 130 generates image data that causes the ink to be injected from the second nozzle.

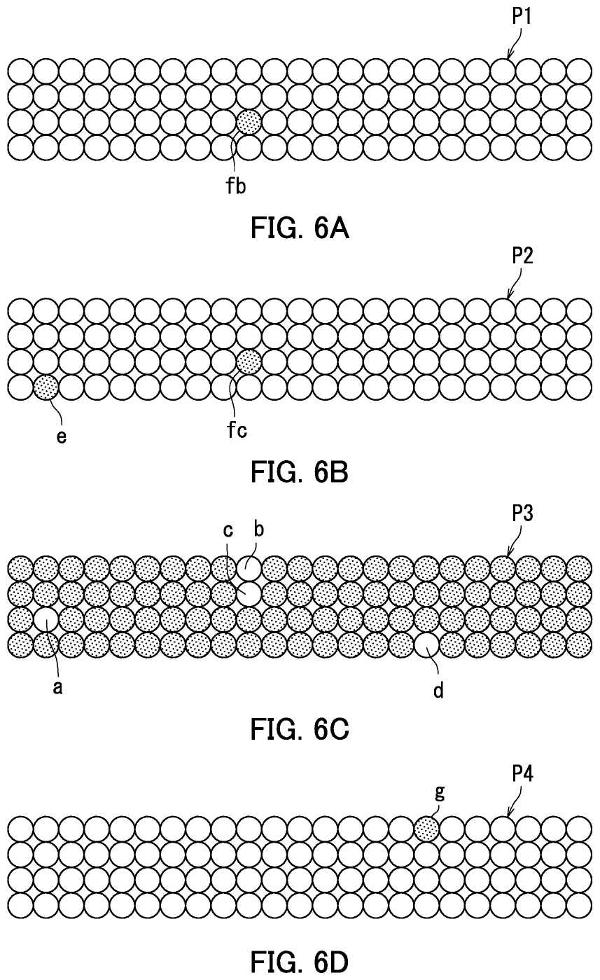

FIG. 6A illustrates the first pattern P1. The first pattern P1 shows that the ink is injected toward a drop landing position fb. The first pattern P1 corresponds to the “second image data”. The drop landing position fb corresponds to the nozzle 74F illustrated in FIG. 5. In the case where the image forming section 7 forms an image on the recording medium S based on the first pattern P1, the ink is injected only from the nozzle 74F. As a result, an image in which the ink is injected to the drop landing position fb is formed on the recording medium S.

FIG. 6B illustrates the second pattern P2. The second pattern P2 shows that the ink is injected toward a drop landing position e and a drop landing position fc. The second pattern P2 corresponds to the “second image data”. The drop landing position e corresponds to the nozzle 74E illustrated in FIG. 5. The drop landing position fc corresponds to the nozzle 74F illustrated in FIG. 5. In the case where the image forming section 7 forms an image on the recording medium S based on the second pattern P2, the ink is injected from the nozzle 74E and the nozzle 74F. As a result, an image in which the ink is injected to the drop landing position e and the drop landing position fc is formed on the recording medium S.

FIG. 6C illustrates the third pattern P3. The third pattern P3 shows that the ink is injected toward drop landing positions excluding the drop landing position a, the drop landing position b, the drop landing position c, and the drop landing position d. The third pattern P3 corresponds to the “first image data”. In the case where the image forming section 7 forms an image on the recording medium S based on the third pattern P3, the ink is injected from the nozzles excluding the nozzle 74A, the nozzle 74B, the nozzle 74C, and the nozzle 74D. As a result, an image in which the ink is injected to the drop landing positions excluding the drop landing position a, the drop landing position b, the drop landing position c, and the drop landing position d is formed on the recording medium S.

FIG. 6D illustrates the fourth pattern P4. The fourth pattern P4 shows that the ink is injected toward a drop landing position g. The fourth pattern P4 corresponds to the “second image data”. The drop landing position g corresponds to the nozzle 74G illustrated in FIG. 5. In the case where the image forming section 7 forms an image on the recording medium S based on the fourth pattern P4, the ink is injected from the nozzle 74G. As a result, an image in which the ink is injected to the drop landing position g is formed on the recording medium S.

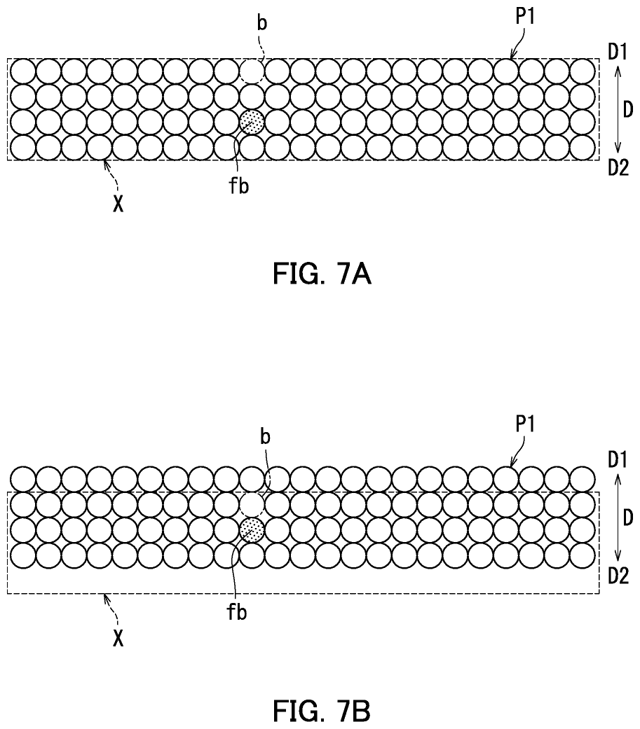

Now, with reference to FIGS. 4A through 7B, a process for adjusting a formation timing at which the image is formed on the recording medium S will be described. The formation timing is a timing at which the image forming section 7 forms an image on the recording medium S based on the image data. FIG. 7A illustrates a state before the formation timing of an image representing the first pattern P1 is adjusted. As illustrated in FIG. 7A, the first pattern P1 is formed in an image formation region X. The image formation region X is a part of the recording medium S. The recording medium S is conveyed from a direction D2 side to a direction D1 side. The direction D1 side is a downstream side with respect to a conveyance direction of the recording medium S. The direction D2 side is an upstream side with respect to the conveyance direction of the recording medium S. FIG. 7B illustrates a state after the formation timing of the image representing the first pattern P1 is adjusted.

Referring to FIG. 7A, in the case where the controller 100 does not adjust the formation timing of the image representing the first pattern P1, the ink injected from the nozzle 74F lands at the drop landing position fb. The drop landing position fb is away from the drop landing position b by two dots. One dot corresponds to one nozzle 74. Therefore, in the case where one drop landing position is away from another drop landing position by two dots, the drop landing positions are away from each other by a distance corresponding to two nozzles 74.

The controller 100 adjusts the formation timing based on the drop landing position corresponding to the first nozzle and the drop landing position fb corresponding to the second nozzle. Specifically, the controller 100 adjusts the formation timing such that the ink injected from the second nozzle lands at a predetermined position. In the case where, for example, the drop landing position b is on the direction D1 side with respect to the drop landing position fb, the controller 100 advances the formation timing. When the formation timing is advanced, the drop landing position fb is moved to the direction D1 side. In the case where the drop landing position b is on the direction D2 side with respect to the drop landing position fb, the controller 100 delays the formation timing. When the formation timing is delayed, the drop landing position fb is moved to the direction D2 side. The formation timing is adjusted on a dot-by-dot basis.

Referring to FIG. 7B, in the case where, for example, the formation timing is adjusted to be advanced by one dot, the position at which the image representing the first pattern P1 is formed is shifted on the direction D1 side by one dot from the image formation region X. Since the position at which the image representing the first pattern P1 is formed is shifted on the direction D1 side by one dot, the drop landing position fb of the ink injected from the nozzle 74F is shifted on the direction D1 side by one dot. As a result, the drop landing position fb of the ink injected from the nozzle 74F is changed to a position that is away from the drop landing position b by one dot.

In the case where the formation timing is adjusted, it may be determined whether or not the ink injected from the second nozzle has landed at the drop landing position corresponding to the first nozzle. In order to determine whether or not the ink injected from the second nozzle has landed at the drop landing position corresponding to the first nozzle, the reading section 4 reads the recording medium S on which the image representing the first pattern P1 is formed. The reading section 4 acquires read data RD from the recording medium S.

The determining section 110 determines whether or not the data representing the test pattern TP and the read data RD match each other. For example, the determining section 110 determines whether the drop landing position b of the test pattern TP and the drop landing position fb of the read data RD illustrated in FIG. 7B match each other. In the case where the drop landing position b of the test pattern TP and the drop landing position fb of the read data RD match each other, the ink injected from the nozzle 74F has landed at the drop landing position corresponding to the nozzle 74B.

As illustrated in FIGS. 7A and 7B, in the case where the drop landing position b of the test pattern TP and the drop landing position fb of the read data RD do not match each other, the ink injected from the nozzle 74F did not land at the drop landing position corresponding to the nozzle 74B. In the case where the drop landing position b of the test pattern TP and the drop landing position fb of the read data RD do not match each other, the controller 100 further adjusts the formation timing. Specifically, the controller 100 adjusts the formation timing such that the ink injected from the nozzle 74F lands at the drop landing position b corresponding to the nozzle 74B. The controller 100 adjusts the formation timing in this manner, so that the ink injected from the second nozzle lands at the drop landing position corresponding to the first nozzle.

Now, with reference to FIGS. 5, 8A, 8B, 8C, 8D and 9, an image formed by an adjustment performed on the formation timing will be described.

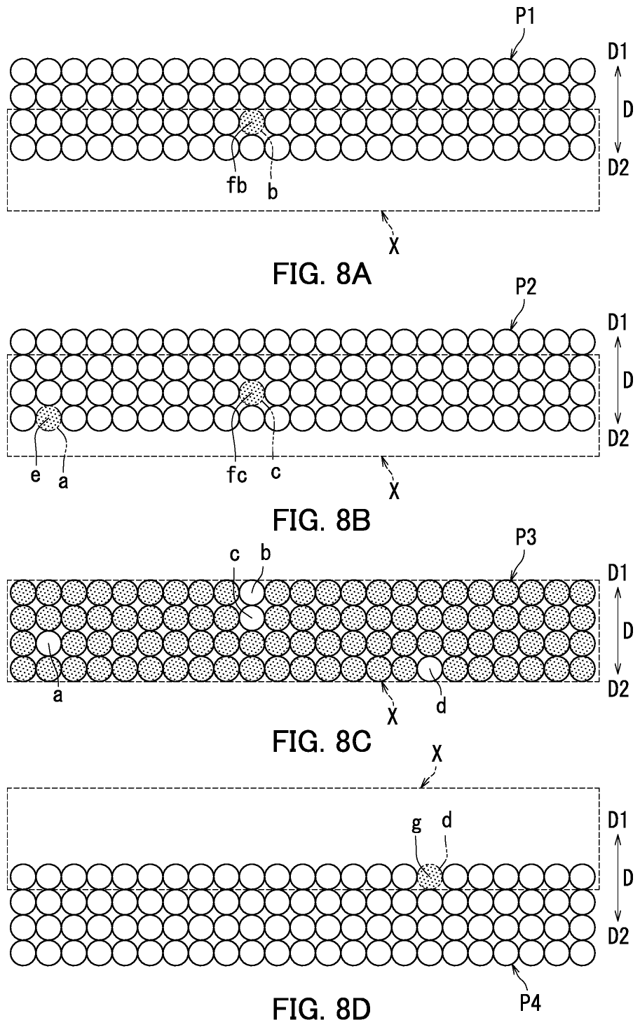

FIG. 8A illustrates a position at which the image representing the first pattern P1 is formed. FIG. 8B illustrates a position at which an image representing the second pattern P2 is formed. FIG. 8C illustrates a position at which an image representing the third pattern P3 is formed. FIG. 8D illustrates a position at which an image representing the fourth pattern P4 is formed.

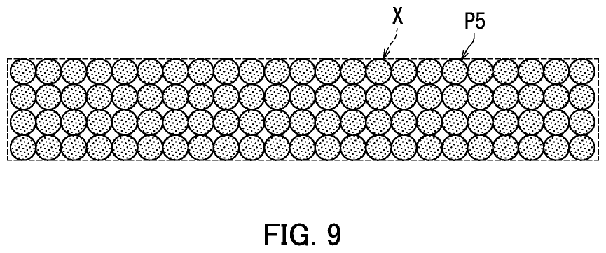

FIG. 9 illustrates an image formed in the image formation region X.

As illustrated in FIG. 8A, in the case where the ink injected from the nozzle 74F illustrated in FIG. 5 is to land at the drop landing position b, the controller 100 adjusts the formation timing of the image representing the first pattern P1 to be advanced by two dots. In the case where the formation timing of the image representing the first pattern P1 is adjusted to be advanced by two dots, the position at which the image is formed is shifted on the direction D1 side by two dots from the image formation region X. Since the position of the image is shifted on the direction D1 side by two dots, the drop landing position fb of the ink injected from the nozzle 74F is shifted on the direction D1 side by two dots. As a result, the drop landing position fb becomes the same as the drop landing position b. Therefore, even in the state where the nozzle 74B is clogged with the thickened ink, the ink is injected toward the drop landing position b from the nozzle 74F.

As illustrated in FIG. 8B, in the case where the ink injected from the nozzle 74E illustrated in FIG. 5 is to land at the drop landing position a, the controller 100 adjusts the formation timing of the image representing the second pattern P2 to be advanced by one dot. In the case where the formation timing of the image representing the second pattern P2 is adjusted to be advanced by one dot, the position at which the image is formed is shifted on the direction D1 side by one dot from the image formation region X. Since the position of the image is shifted on the direction D1 side by one dot, the drop landing position e of the ink injected from the nozzle 74E is shifted on the direction D1 side by one dot. As a result, the drop landing position e becomes the same as the drop landing position a. Therefore, even in the state where the nozzle 74A is clogged with the thickened ink, the ink is injected toward the drop landing position a from the nozzle 74E.

As illustrated in FIG. 8B, in the case where the ink injected from the nozzle 74F illustrated in FIG. 5 is to land at the drop landing position c, the controller 100 adjusts the formation timing of the image representing the second pattern P2 to be advanced by one dot. In the case where the formation timing of the image representing the second pattern P2 is adjusted to be advanced by one dot, the position at which the image is formed is shifted on the direction D1 side by one dot from the image formation region X. Since the position of the image is shifted on the direction D1 side by one dot, the drop landing position fc of the ink injected from the nozzle 74F is shifted on the direction D1 side by one dot. As a result, the drop landing position fc becomes the same as the drop landing position c. Therefore, even in the state where the nozzle 74C is clogged with the thickened ink, the ink is injected toward the drop landing position c from the nozzle 74F.

As illustrated in FIG. 8C, the controller 100 controls the image forming section 7 to form an image in the image formation region X of the recording medium S based on the third pattern P3. Specifically, the controller 100 controls the image forming section 7 to inject the ink toward the drop landing positions excluding the drop landing position a, the drop landing position b, the drop landing position c, and the drop landing position d, based on the third pattern P3.

As illustrated in FIG. 8D, in the case where the ink injected from the nozzle 74G illustrated in FIG. 5 is to land at the drop landing position d, the controller 100 adjusts the formation timing of the image representing the fourth pattern P4 to be delayed by three dots. In the case where the formation timing of the image representing the fourth pattern P4 is adjusted to be delayed by three dots, the position at which the image is formed is shifted on the direction D2 side by three dots from the image formation region X. Since the position of the image is shifted on the direction D2 side by three dots, the drop landing position g of the ink injected from the nozzle 74G is shifted on the direction D2 side by three dots. As a result, the drop landing position g becomes the same as the drop landing position d. Therefore, even in the state where the nozzle 74D is clogged with the thickened ink, the ink is injected toward the drop landing position d from the nozzle 74G.

As illustrated in FIGS. 8A through 8D, the image representing the first pattern P1, the image representing the second pattern P2, the image representing the third pattern P3, and the image representing the fourth pattern P4 are formed in the image formation region X. As a result, as shown in FIG. 9, an image P5 is formed. The image P5 is in the state where the ink has been injected to all the drop landing positions. As described above, the controller 100 adjusts the formation timing when an image is to be formed based on image data generated by the generating section 130, so that the ink injected from the second nozzle lands at the drop landing position at which the ink injected from the first nozzle is to land. As a result, the ink is injected toward the drop landing position corresponding to the nozzle clogged with the thickened ink while generation of detects in the image is suppressed, and thus the image is formed. Namely, even if the first nozzle is clogged with thickened ink, an image is formed with the ink injected from the second nozzle. Since the amount of the ink injected from the second nozzle is not changed, generation of defects in the image is suppressed.

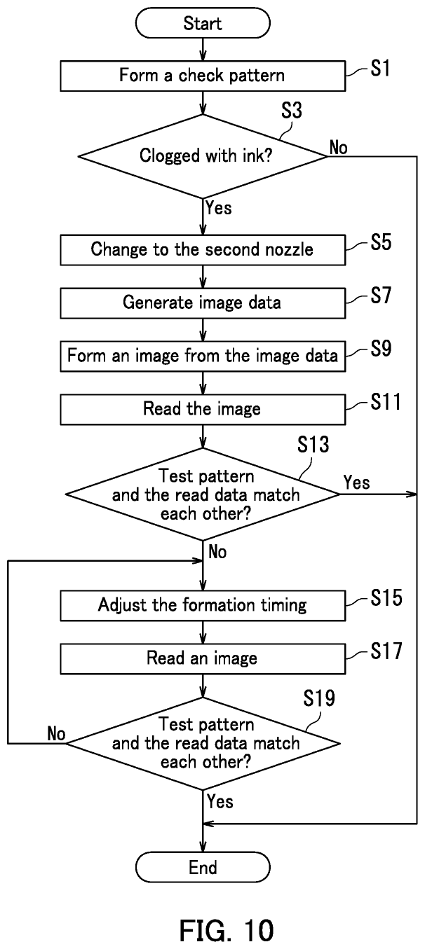

Now, with reference to FIGS. 1 through 10, a process performed by the inkjet recording apparatus 1 will be described. FIG. 10 is a flowchart illustrating a process executed by the controller 100. As illustrated in FIG. 10, the process executed by the controller 100 includes Steps S1 through S19.

In Step S1, the controller 100 controls the image forming section 7 to form the check pattern CP. The process advances to Step S3.

In Step S3, the determining section 110 determines whether each of the nozzles 74 is clogged with thickened ink, based on the test pattern TP and the check pattern CP. In the case where the determining section 110 determines that the nozzle 74 is not clogged with the ink (No in Step S3), the process is finished. In the case where the determining section 110 determines that the nozzle 74 is clogged with the ink (Yes in Step S3), the process advances to Step S5.

When the determination result in Step S3 is Yes, in Step S5, the changing section 120 changes the nozzle 74 to inject the ink, from the first nozzle to the second nozzle, based on such a determination result of the determining section 110. The process advances to Step S7.

In Step S7, the generating section 130 generates image data based on the determination result 110. The process advances to Step S9.

In Step S9, the controller 100 controls the image forming section 7 to form an image on the recording medium S based on the image data. The process advances to Step S11.

In Step S11, the controller 100 controls the reading section 4 to read the image formed on the recording medium S. The image data read by the reading section 4 is stored on the storage 9 as read data RD. The process advances to Step S13.

In Step S13, the determining section 110 determines whether or not the data representing the test pattern TP and the read data RD match each other. In the case where the determining section 110 determines that the data representing the test pattern TP and the read data RD match each other (Yes in Step S13), the process is finished. In the case where the determining section 110 determines that the data representing the test pattern TP and the read data RD do not match each other (No in Step S13), the process advances to Step S15.

When the determination result in Step S13 is No, in Step S15, the controller 100 adjusts the formation timing based on the image data such that the ink injected from the second nozzle lands at a predetermined position. The controller 100 also forms an image on the recording medium S based on the adjusted formation timing. The process advances to Step S17.

In Step S17, the controller 100 controls the reading section 4 to read the image formed on the recording medium S. The image data read by the reading section 4 is stored on the storage 9 as read data RD. The process advances to Step S19.

In Step S19, the determining section 110 determines whether or not the data representing the test pattern TP and the read data RD match each other. In the case where the determining section 110 determines that the data representing the test pattern TP and the read data RD do not match each other (No in Step S19), the process returns to Step S15. In the case where the determining section 110 determines that the data representing the test pattern TP and the read data RD match each other (Yes in Step S19), the process is finished.

Embodiments of the present disclosure are described above with reference to the drawings (FIGS. 1 through 10). The present disclosure is not limited to any of the above-described embodiments, and may be carried out in any of various forms without departing from the gist thereof. The plurality of elements disclosed in the above-described embodiments may be appropriately combined to realize various disclosures. For example, some of the elements among all the elements described in the embodiments may be deleted. The elements described in different embodiments may be appropriately combined. The drawings mainly illustrate the elements schematically for easier understanding. The thickness, length, number, interval, and the like of each of the elements illustrated in the drawings may be different from the actual thickness, length, number, interval, and the like for the reason related to the drafting of the drawings. The speed, material, shape, size, or the like of each of the elements described in the embodiments is merely an example and is not limiting, and may be modified in any of various manners without substantially departing from the configuration of the present disclosure.

What is claimed is:

1. An inkjet recording apparatus comprising:
an image forming section including a plurality of nozzles, the image forming section being configured to inject ink from the plurality of nozzles to form an image on a recording medium; and
a controller configured to control the image forming section, wherein
the controller includes
a determining section configured to determine whether or not each of the plurality of nozzles is clogged with the ink in a thickened state,
a changing section configured to change the nozzle to inject the ink, from a first nozzle to a second nozzle, based on a determination result of the determining section, and
a generating section configured to generate image data based on the determination result of the determining section,
the controller controls the image forming section to inject the ink from the second nozzle to form an image on the recording medium based on the image data,
the first nozzle is clogged with the ink in the thickened state, and
the second nozzle is different from the first nozzle.

2. The inkjet recording apparatus according to claim 1, wherein
the controller controls the image forming section such that the ink injected from the second nozzle lands at a predetermined position on the recording medium, and
the predetermined position is a position at which the ink injected from the first nozzle is to land.

3. The inkjet recording apparatus according to claim 2, wherein
the controller adjusts a formation timing such that the ink injected from the second nozzle lands at the predetermined position, and
the formation timing represents a timing at which the image forming section forms an image on the recording medium based on the image data.

4. The inkjet recording apparatus according to claim 2, wherein
the generating section generates first image data and second image data,
the first image data shows that the ink is injected toward a position excluding the predetermined position, and
the second image data shows that the ink is injected toward only the predetermined position.

5. The inkjet recording apparatus according to claim 4, further comprising:
storage configured to store data representing a test pattern; and
a reading section configured to read the image formed on the recording medium based on the image data, wherein
the determining section determines whether or not the data representing the test pattern and data read by the reading section match each other, and
the test pattern is image data formed when the ink is injected from each of the plurality of nozzles.

6. The inkjet recording apparatus according to claim 1, further comprising a conveyance mechanism configured to convey the recording medium in a predetermined direction, wherein
the first nozzle and the second nozzle are located on the same line as each other, and
a direction in which the first nozzle and the second nozzle are located on the same line as each other matches the predetermined direction.

7. An image forming method performed by an inkjet recording apparatus including an image forming section configured to inject ink from a plurality of nozzles to form an image on a recording medium, the method comprising:
controlling the image forming section;
determining whether or not each of the plurality of nozzles is clogged with the ink in a thickened state;
changing the nozzle to inject the ink, from a first nozzle to a second nozzle, based on a determination result on whether or not each of the plurality of nozzles is clogged with the ink;
generating image data based on the determination result on whether or not each of the plurality of nozzles is clogged with the ink; and
the image forming section injecting the ink from the second nozzle to form an image on the recording medium based on the image data, wherein
the first nozzle is clogged with the ink, and
the second nozzle is different from the first nozzle.
